(19) United States
(12) Patent Application Publication
(10) Pub. No.: US 2023/0383592 A1
(43) Pub. Date: Nov. 30, 2023

(54) BUILDING ENTRY SECURITY DOOR SYSTEM

(71) Applicant: Calvin White, Woodward, OK (US)

(72) Inventor: Calvin White, Woodward, OK (US)

(21) Appl. No.: 18/204,047

(22) Filed: May 31, 2023

Related U.S. Application Data
(60) Provisional application No. 63/347,253, filed on May 31, 2022.

(51) Int. Cl. E06B 5/11; E05B 37/00; G01V 9/00; H04N 7/18

(52) U.S. Cl. CPC E06B 5/11; E05B 37/00; G01V 9/00; H04N 7/18

(57) ABSTRACT

A security door system for use with an existing building having an existing door. The security door system including a first secure wall and a first security door disposed in the first secure wall. The security door system also including a second secure wall extending from the first secure wall to the existing building and a third secure wall extending from the first secure wall to the existing building. The security door system further including a secure top supported by the first, second and third secure walls to create a first secure area. A method of monitoring and controlling who has access to an existing building. The method includes installing the security door system for the existing building to permit only authorized individuals to enter and permitting access of the authorized individuals to the existing building via the security door system.

### CROSS-REFERENCE TO RELATED APPLICATIONS

The present application is a conversion of U.S. Provisional Application having U.S. Ser. No. 63/347,253, filed May 31, 2022, which claims the benefit under 35 U.S.C. 119(e). The disclosures of which are hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to a security door system that is securable adjacent to an entry point of an existing building.

### 2. Description of the Related Art

Currently, a number of existing building, such as schools, do not have any type of security system in place for entry points to the building. Entry points would basically be the doors used to access the existing building. Typically, entry doors for an existing building can be locked and that is the extent of the security. So, when the building in use, the doors are unlocked and people can come and go. To alter this setup of the entry doors for the existing building would be expensive and take a significant amount of time.

Accordingly, there is a need for a security door system that can be used with an existing building.

### SUMMARY OF THE DISCLOSURE

The present disclosure is directed to a security door system for use with an existing building having an existing door. The security door system including a first secure wall and a first security door disposed in the first secure wall. The security door system also including a second secure wall extending from the first secure wall to the existing building and a third secure wall extending from the first secure wall to the existing building. The security door system further including a secure top supported by the first, second and third secure walls to create a first secure area.

The present disclosure also directed to a method of monitoring and controlling who has access to an existing building. The method includes installing the security door system for the existing building to permit only authorized individuals to enter and permitting access of the authorized individuals to the existing building via the security door system.

### BRIEF DESCRIPTION OF THE DRAWINGS

FIGS. 1A and 1B are perspective views of one embodiment of a security door system constructed in accordance with the present disclosure.

FIGS. 2A-2E are perspective views of another embodiment of the security door system constructed in accordance with the present disclosure.

FIGS. 3A and 3B are perspective views of yet another embodiment of the security door system constructed in accordance with the present disclosure.

### DETAILED DESCRIPTION OF THE DISCLOSURE

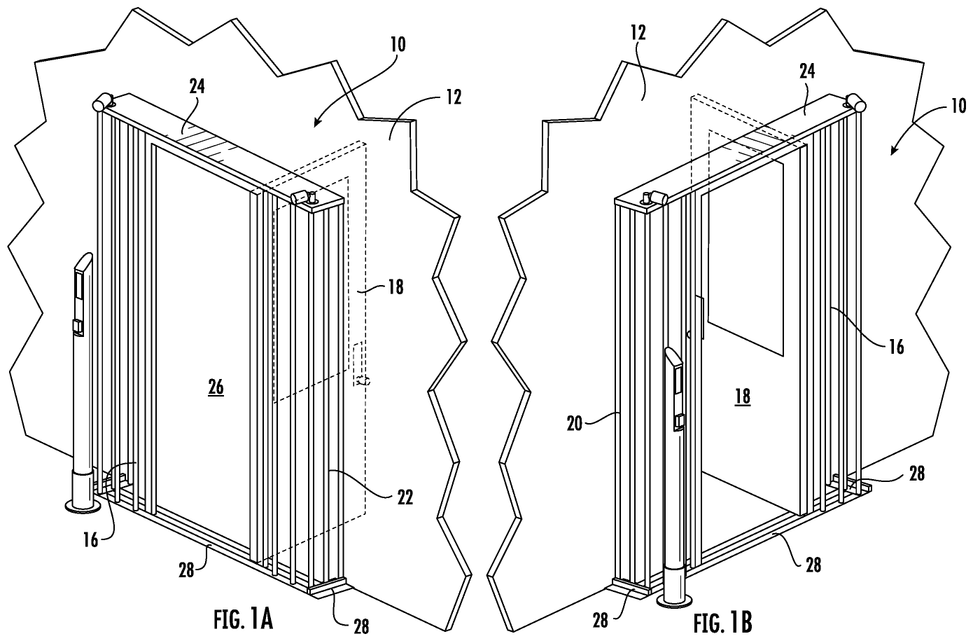

Referring now to FIGS. 1-3B, the present disclosure relates to a security door system 10 that can be installed adjacent to an existing building/wall 12 to coordinate with the existing entry doors 14 on the existing building 12 and provide increased security measures the existing doors 14 do not have. The security door system 10 can be used in situations where secure entry is required and major renovation does not have to occur to the existing building 12. While the primary use of the security door system 10 will be for use with entry doors 14 to the existing building 12, the security door system 10 could be used with existing internal doors (not shown) as well if desired. The security door system 10 can be designed in various manners to accommodate different existing door designs. For example, the existing door 14 can open inwards, outwards or both. The security door system 10 can also be designed to be implemented on the inside of an existing door 14.

In one embodiment, the security door system 10 can have a first secure wall 16 with a first security door 18 disposed therein and a second secure wall 20 secured to the first secure wall 18 that extends to the building wall 12 adjacent to the building door 14. The security door system 10 also includes a third secure wall 22 secured to the other side of the first secure wall 16 from the second secure wall 20 and extends from the first secure wall 16 to the building wall 12 adjacent to the other side of the building door 14 from the second secure wall 20. The security door system 10 can also include a secure top 24 that is attached to the first, second and third secure walls 16, 20 and 22 to create a first secure area 26. The first secure area 26 is the area inside the first, second and third secure walls 16, 20 and 22, the secure top 24, the existing building 12 and the ground. Each secure wall 16, 20 or 22 can include a base portion 28 that has holes disposed therein. The holes can be engaged by a securing means to secure the secure walls 16, 20 and 22 to the ground. The securing means can be any device known in the art for securing the base portions 28 to the ground. Examples of securing devices include, but are not limited to, anchor bolts, screws, etc. The type of securing device used can depend on the type of ground the security door system 10 will be secured to. The second and third secure walls 20 and 22 can be configure to be secured to the building wall. The security door system 10 can also be secured to the existing building 12 in addition to, or in lieu of, being secured to the ground.

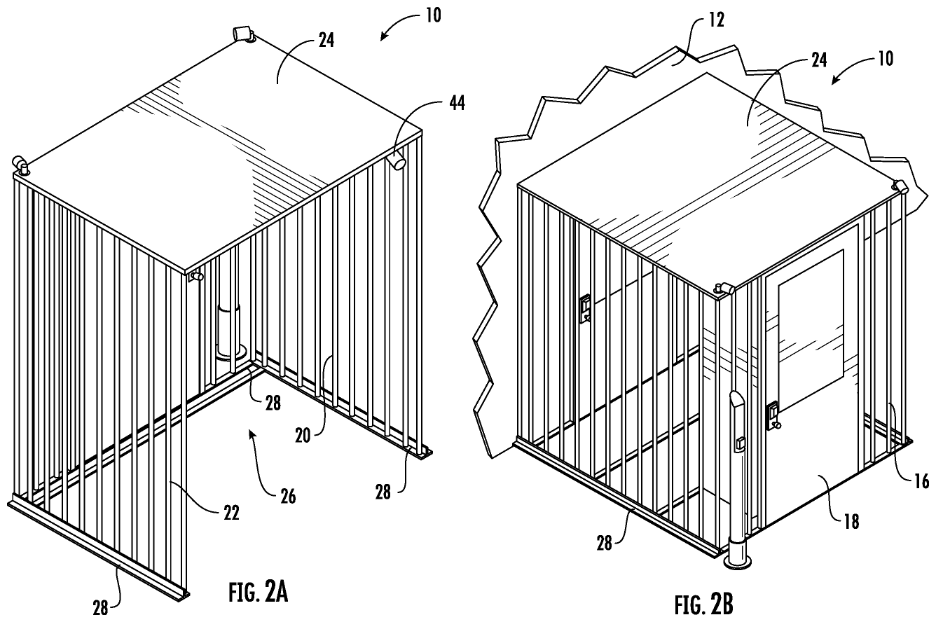

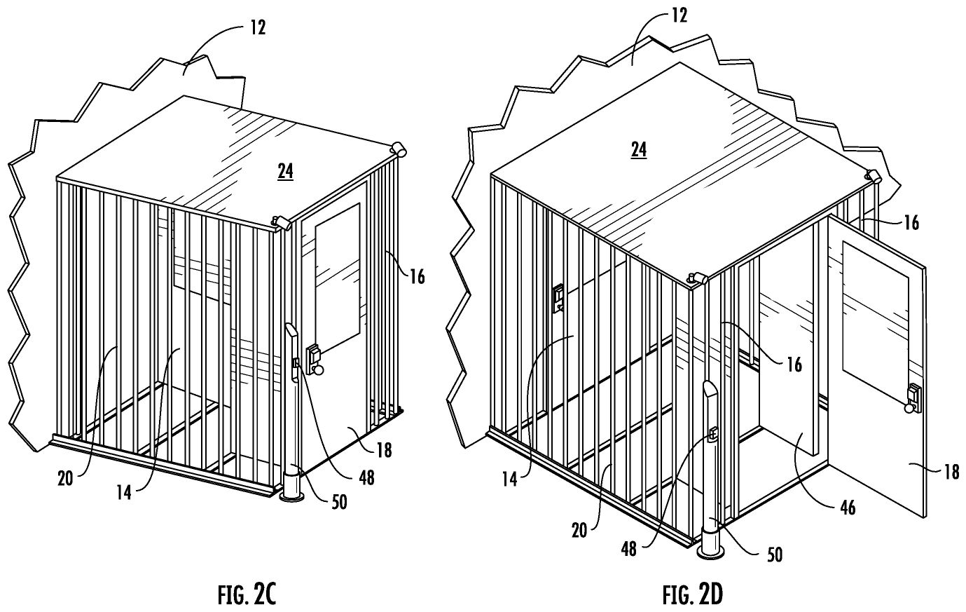

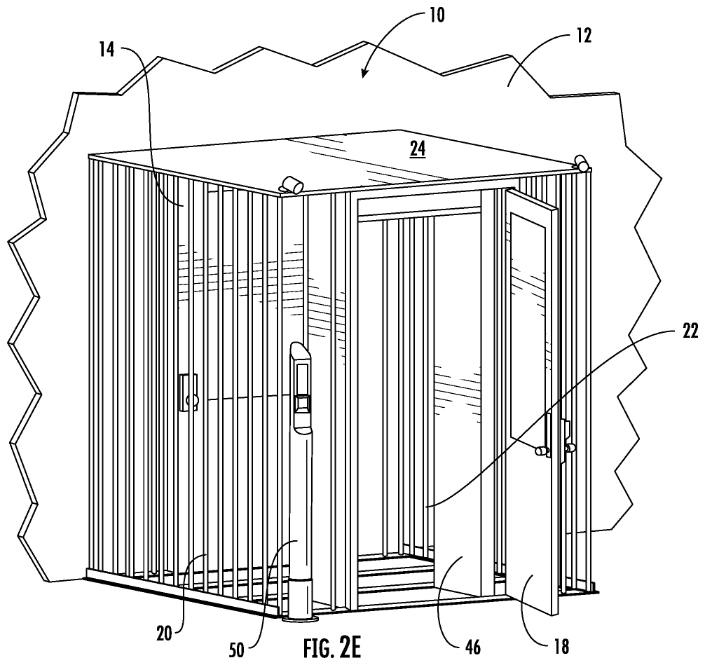

Referring now to FIGS. 2A-2E, the length of the second and third secure walls 20 and 22 (distance between existing building 12 and the first secure wall 16) will depend on the configuration of the existing door 14 and whether the security door system 10 is on the inside or outside of the building 12. For example, the length of the second and third secure walls 20 and 22 would not need to be very long if the building door 14 opens inward and the security door system 10 is installed on the outside of the building 12. The length of the second and third secure walls 20 and 22 will need to be longer when the building door 14 opens outward and the security door system 10 is installed outside the building 12 or the building door 14 opens inward and the security door system 12 is installed inside the building 12 to accommodate for the existing door 14 and the person entering the building in the first secure area 26.

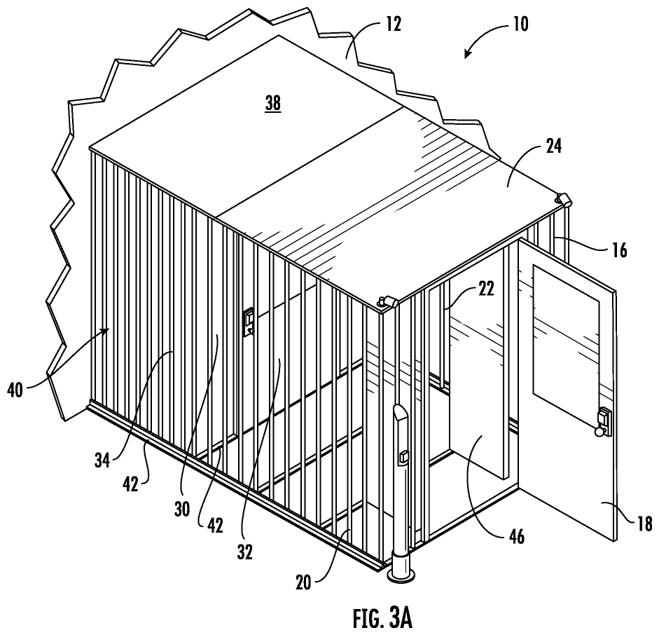

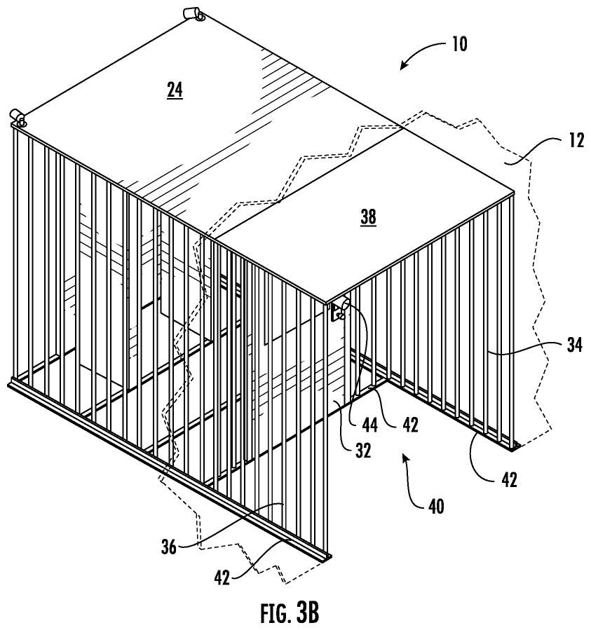

In another embodiment of the present disclosure shown in more detail in FIGS. 3A-3B, the security door system 12 can include a fourth secure wall 30 with a second security door 32 disposed therein and a fifth secure wall 34 that extends from the first secure wall 16 to the fourth secure wall 30. The security door system 10 also includes a sixth secure wall 36 that extends from the first secure wall 16 to the fourth secure wall 30. The security door system 10 can also include a second secure top 38 that is attached to the first, fourth, fifth and sixth secure walls 16, 30, 34 and 36 to create a second secure area 40. The second secure area 42 is the area inside the first, fourth, fifth and sixth secure walls 16, 30, 34 and 36, the second secure top 38, and the ground. Each secure wall 30, 34 and 36 can include a base portion 42 that has holes disposed therein. The holes can be engaged by a securing means to secure the secure walls 30, 34 and 36 to the ground. The securing means can be any device known in the art for securing the base portions 42 to the ground. Examples of securing devices include, but are not limited to, anchor bolts, screws, etc. The type of securing device used can depend on the type of ground the security door system 10 will be secured to. It should be understood and appreciated that the second secure top 38 and the first secure top 24 can be made up of a single piece of material.

The secure walls 16, 20, 22, 30, 34 and 36 disclosed herein can be constructed of any material or have any construction such that a person is prevented from gaining access to the first or second secure areas 26 and 40 and thus, the existing building 12. The secure walls 16, 20, 22, 30, 34 and 36 can be constructed of a series of bars such that the first or second secure areas 26 and 40 are visible from outside of the security door system. The secure tops 24 and 38 can be constructed similarly to the secure walls 16, 20, 22, 30, 34 and 36.

The security door system 10 can include cameras 44 that monitor the first and/or second secure area 26 and/or 40, or any area adjacent to the security door system 10. The first and second security doors 18 and 32 can be set up to where they can be electronically opened by someone inside the building who is monitoring the cameras 44. The security door(s) 18 and 32 can only be opened if the person attempting to gain access to the building is recognized via the cameras 44. The security door system 10 can also include metal detectors 46 built into it. The metal detectors 46 can be built into the security doors 18 and 32, built as stand-alone units in the secure areas 26 and 40 of the security door system 10.

The first and second security doors 18 and 32 can include any locking technology known in the art. For example, each security door 18 and 32 can include a key pad 48 disposed thereon or the security doors 18 and 32 can be equipped with RFID technology that only unlocks for a person who has an approved RFID tag. The technology for opening the security doors 18 and 32 (i.e., keypad, RFID, etc.) can be located on a separate device 50 from the doors 18 and 32 such as a post 50. Each security door 18 or 32 can have its own locking system wherein each door can be locked and unlocked independent of each other. The security door system 10 can be set up where the security doors 18 and 32 are only lockable in the entry direction. Thus, anyone wishing to exit the building will not be prevented from doing so by the security doors 18 and 32. The first security door 18 and the second security door 32 can be constructed of any materials or combination of materials, such as steel, steel reinforced glass, etc. that can provide substantial resistance to undesired entry.

The present disclosure is also directed to monitoring, restricting and/or managing access to the existing buildings 12 the security door system 10 are installed on. The security door system 10 prevents access to the building 12 of anyone not permitted to have access during any time frame desirable by the owners/managers/administrators of the building 12.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A security door system for use with an existing building having an existing door, the system comprising:
a first secure wall;
a first security door disposed in the first secure wall;
a second secure wall extending from the first secure wall to the existing building;
a third secure wall extending from the first secure wall to the existing building; and
a secure top supported by the first, second and third secure walls to create a first secure area.

2. The security door system of claim 1 wherein the secure walls include base portions securable to the ground adjacent to the existing door of the existing building.

3. The security door system of claim 1 wherein the second and third secure walls are securable to the existing building.

4. The security door system of claim 1 further comprising a camera for viewing that area around the security door system and the first secure area.

5. The security door system of claim 1 further comprising a metal detector.

6. The security door system of claim 1 wherein security door system can be installed on an inside of the existing building or on an outside of the existing building.

7. The security door system of claim 1 further comprising:
a fourth secure wall;
a second security door disposed in the fourth secure wall;
a fifth secure wall extending from the fourth secure wall or the second secure wall to the existing building;
a sixth secure wall extending from the fourth secure wall or the third secure wall to the existing building; and
a second secure top supported by the fourth, fifth and sixth secure walls to create a second secure area.

8. The security door system of claim 7 wherein the first and second security doors can have their own keypad.

9. The security door system of claim 7 wherein the fourth, fifth and sixth secure walls can be secured to the ground or to the existing building adjacent to the existing door.

10. The security door system of claim 7 wherein the fourth secure wall and the second security door separates the first secure area from the second secure area.

11. A method of monitoring and controlling who has access to an existing building, the method comprising:
installing a security door system for the existing building to permit only authorized individuals to enter; and
permitting access of the authorized individuals to the existing building via the security door system.

12. The method of claim 11 wherein security door system comprises:
a first secure wall;
a first security door disposed in the first secure wall;
a second secure wall extending from the first secure wall to the existing building;
a third secure wall extending from the first secure wall to the existing building; and
a secure top supported by the first, second and third secure walls to create a first secure area.

13. The method of claim 12 wherein the secure walls include base portions securable to the ground adjacent to the existing door of the existing building.

14. The method of claim 12 wherein the second and third secure walls are securable to the existing building.

15. The method of claim 12 further comprising a camera for viewing that area around the security door system and the first secure area.

16. The method of claim 12 wherein security door system can be installed on an inside of the existing building or on an outside of the existing building.

17. The method of claim 12 further comprising:
a fourth secure wall;
a second security door disposed in the fourth secure wall;
a fifth secure wall extending from the fourth secure wall or the second secure wall to the existing building;
a sixth secure wall extending from the fourth secure wall or the third secure wall to the existing building; and
a second secure top supported by the fourth, fifth and sixth secure walls to create a second secure area.

18. The method of claim 17 wherein the first and second security doors can have their own keypad.

19. The method of claim 17 wherein the fourth, fifth and sixth secure walls can be secured to the ground or to the existing building adjacent to the existing door.

20. The method of claim 17 wherein the fourth secure wall and the second security door separates the first secure area from the second secure area.
